(19) United States
(12) Patent Application Publication
(10) Pub. No.: US 2020/0111476 A1
(43) Pub. Date: Apr. 9, 2020

(54) RECORDING MEDIUM, LANGUAGE IDENTIFICATION METHOD, AND INFORMATION PROCESSING DEVICE

(71) Applicant: FUJITSU LIMITED, Kawasaki-shi (JP)

(72) Inventors: Akira Kamano, Kawasaki (JP); Yohei KISHI, Kawasaki (JP); Chisato Shioda, Sagamihara (JP); Nobuyuki WASHIO, Akashi (JP); Masanao SUZUKI, Yokohama (JP)

(73) Assignee: FUJITSU LIMITED, Kawasaki-shi (JP)

(21) Appl. No.: 16/577,804

(22) Filed: Sep. 20, 2019

(30) Foreign Application Priority Data
Oct. 4, 2018 (JP) 2018-189242

(51) Int. Cl. G10L 15/00; G06F 17/28; G10L 15/02

(52) U.S. Cl. CPC G10L 15/005; G10L 2015/025; G10L 15/02; G06F 17/289

(57) ABSTRACT

A non-transitory computer-readable recording medium stores therein a program for causing a computer to execute processing including: converting a speech recognition result of speech recognition performed on an input voice for each of a plurality of languages into a phoneme string; calculating a phoneme count for each of the plurality of languages from the corresponding one of the phoneme strings obtained by the conversion for the respective languages; and identifying a type of language matched with the input voice based on the phoneme counts calculated for the respective languages.

### CROSS-REFERENCE TO RELATED APPLICATION

This application is based upon and claims the benefit of priority of the prior Japanese Patent Application No. 2018-189242, filed on Oct. 4, 2018, the entire contents of which are incorporated herein by reference.

### FIELD

The embodiments discussed herein relate to a recording medium, a language identification method, and a language identification device.

### BACKGROUND

Speech translation supporting multiple languages is utilized with the increase of foreign visitors.

Related techniques are disclosed in, for example, Japanese Laid-open Patent Publication No. 2013-061402 and Non Patent Literature: J. L. Hieronymus and S. Kadambe, “Robust spoken language identification using large vocabulary speech recognition”, 1997 IEEE International Conference on Acoustics, Speech, and Signal Processing.

### SUMMARY

According to an aspect of the embodiments, a non-transitory computer-readable recording medium stores therein a program for causing a computer to execute processing including: converting a speech recognition result of speech recognition performed on an input voice for each of a plurality of languages into a phoneme string; calculating a phoneme count for each of the plurality of languages from the corresponding one of the phoneme strings obtained by the conversion for the respective languages; and identifying a type of language matched with the input voice based on the phoneme counts calculated for the respective languages.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a configuration of a speech translation system according to Embodiment 1;

FIG. 2 is a diagram illustrating an example of speech recognition results;

FIG. 3 is a diagram illustrating an example of sentence likelihoods;

FIG. 4 is a diagram illustrating an example of a graph relating to a phoneme count;

FIG. 5 is a diagram illustrating an example of comparison between identification results of phonemes;

FIG. 6 is a diagram illustrating an example of phoneme counts of speech recognition results;

FIG. 7 is a block diagram illustrating an example of a functional configuration of a speech translation server according to Embodiment 1;

FIG. 8 is a flowchart illustrating a procedure of speech translation processing according to Embodiment 1;

FIG. 9 is a block diagram illustrating an example of a functional configuration of a speech translation server according to Embodiment 2;

FIG. 10 is a flowchart illustrating a procedure of speech translation processing according to Embodiment 2;

FIG. 11 is a diagram illustrating an example of language identification results of an input voice;

FIG. 12 is a diagram illustrating an example of correct rates in different language identification methods; and

FIG. 13 is a diagram illustrating an example of a hardware configuration of a computer for executing a language identification program according Embodiments 1 and 2.

### DESCRIPTION OF EMBODIMENTS

In multilingual speech translation, a type of a speech recognition engine to be applied to speech of a foreign person is changed depending on the type of language used in the speech by the foreign person. From this viewpoint, the multilingual speech translation may include a function for Identifying a type of language matched with an input voice. For example, the function identifies the type of language matched with the input voice by receiving an operation for specifying the type of language via a user interface implemented by hardware or software.

However, since the hands of the speaker is occupied for the manual operation for specifying the type of language, the above technique does not allow the identification of the type of language in a hands-free manner.

In one aspect, a language identification program, a language identification method, and a language identification device, which enable the identification of a type of language in a hands-free manner, may be provided.

Hereinafter, a language identification program, a language identification method, and a language identification device according to the present disclosure are described with reference to the accompanying drawings. Note that the embodiments discussed herein are not intended to limit the technical scope of the present disclosure. The embodiments may be combined as appropriate within a range where the processing details are not inconsistent.

### Embodiment 1

[System Configuration]

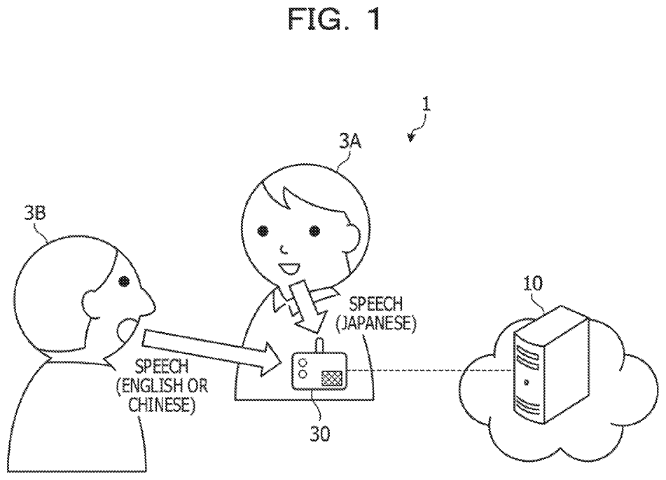

FIG. 1 is a diagram illustrating an example of a configuration of a speech translation system according to Embodiment 1. FIG. 1 illustrates an example in which speech translation is applied to multilingual communication performed at a medical site just as an example of a use case in which speech translation is implemented in a computer system.

A speech translation system 1 illustrated in FIG. 1 provides a speech translation service for assisting multilingual communication between a medical personnel 3A and a foreign patient 3B by speech translation. The “medical personnel” mentioned here is not limited to a doctor or the like, but may include not only healthcare professionals including doctors, but also general staff such as office clerks in charge of reception, accounting, and so on.

As illustrated in FIG. 1, the speech translation system 1 includes a speech translation server 10 and a speech translation terminal 30. In FIG. 1, one speech translation terminal 30 is illustrated for the sake of convenience, but any number of speech translation terminals 30 may be coupled to the speech translation server 10.

The speech translation server 10 is a computer that provides the speech translation service described above.

In one aspect, the speech translation server 10 may be implemented by installing, on any computer, a speech translation program as package software or online software which implements functions for the speech translation service described above. For example, the speech translation server 10 may be implemented as an on-premises server that provides the speech translation service described above, or may be implemented as an outsourcing cloud that provides the speech translation service described above.

The speech translation terminal 30 is a computer that receives the speech translation service described above.

In one embodiment, from the viewpoint of realizing speech translation in a hands-free and eyes-free manner, the speech translation terminal 30 may be implemented as a wearable terminal mounted with hardware such as a microphone for converting voices into electrical signals and a speaker for outputting various voices. As just one example, as illustrated in FIG. 1, the speech translation terminal 30 is implemented as a nameplate wearable terminal, and this nameplate wearable terminal is attached to the chest or the like of the medical personnel 3A, so that speech translation may be performed in a state where the hands of the medical person 3A are not occupied. Although the example in which the speech translation terminal 30 is attached to the medical personnel 3A is described just as one example, the wearer may be the foreign patient 3B. Also, the speech translation terminal 30 may not necessarily be implemented as a wearable terminal, but may be a portable terminal device such as a tablet terminal or a stationary computer such as a personal computer.

As an example, the following data are transmitted and received between the speech translation server 10 and the speech translation terminal 30. For example, from the viewpoints of reduction in the data transmission volume in the network, privacy protection, and the like, the speech translation terminal 30 detects a speech segment from a voice input to a microphone (not illustrated), and transmits voice data of the speech segment to the speech translation server 10. In this process, the speech translation terminal 30 may detect the speech start and speech end based on the amplitude and zero-crossing of the waveform of the input voice signal, or may calculate a voice likelihood and a non-voice likelihood in accordance with a Gaussian mixture model (GMM) for each frame of the voice signal, and detect the speech start and speech end from the ratio of these likelihoods. Meanwhile, the speech translation server 10 performs speech translation on the voice data of the speech segment transmitted from the speech translation terminal 30, and then transmits data of synthesized voice generated from the text of the speech after translation to the speech translation terminal 30. The speech translation terminal 30 to which the synthesized voice is transmitted as described above outputs the synthesized voice from a speaker (not Illustrated) or the like.

As illustrated in FIG. 1, the speech translation service described above is provided in an environment in which multiple types of foreign languages are used. For example, while the type of language used in speech by the medical personnel 3A is Japanese only, the languages used in speech by foreign patients 3B are not necessarily of one type. For example, like a case where the type of language used in speech by a foreign patient 3B is English and the type of language used in speech by another foreign patient 3B is Chinese, the speech translation service is provided under an environment of multilingual usage in which foreign patients 3B individually use different types of languages in speeches.

[One Aspect of Problem]

In the multilingual speech translation like this, the type of speech recognition engine to be applied to a speech of a foreign person is also changed depending on the type of language used in the speech by the foreign person as described above. From this viewpoint, the multilingual speech translation may include a function for identifying a type of language matched with an input voice.

However, if the type of language is specified by a manual operation as described in the background art, the hands of a speaker are occupied by the operation. For this reason, situations where the personnel works without touching the terminal by the hands are limited. For example, in the medical site, the works of the medical personnel 3A are behind in various situations such as reception, inspection, examination, treatment, ward, and accounting, and there may be a hygienic disadvantage in that the contact to an object not disinfected or sterilized increases a risk of infection.

On the other hand, there is also a language identification system (LID) that uses a voice to identify the type of language. That is, the language identification system performs speech recognition of an input voice for each of multiple languages, and calculates a sentence likelihood of the speech recognition result for each of the multiple languages. In this process, the sentence likelihood is calculated by using a linguistic model in which a feature of each word order, for example, an existence probability of the word order is statistically modeled, and an acoustic model in which an acoustic feature, for example, an existence probability of phonemes is statistically modeled. Needless to say, the linguistic model and the acoustic model are modeled for each of the multiple languages. Furthermore, the language identification system identifies the language with the highest sentence likelihood among the multiple languages as a used language.

However, in the above language identification system, the accuracy in identification of a language may deteriorate for the following reason. For example, the above language identification system merely determines the sentence likelihood based on the statistical probability. For this reason, in the case where a speech that may possibly be matched with some languages in terms of both linguistic features and acoustic features is input as a voice, the language identification system described above may erroneously identify the type of language in the speech.

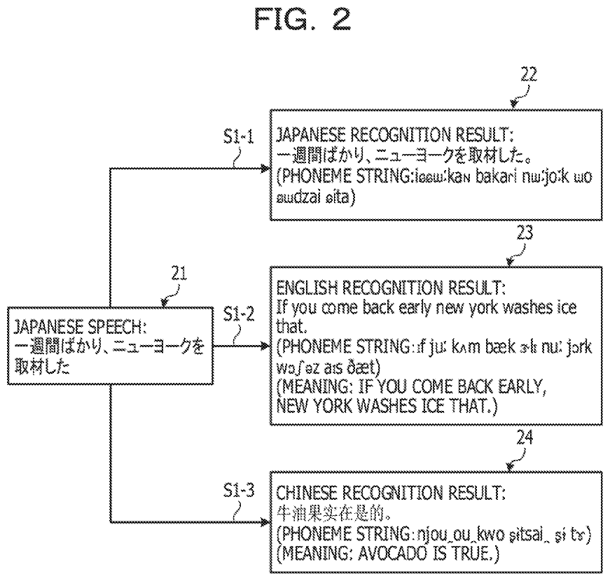

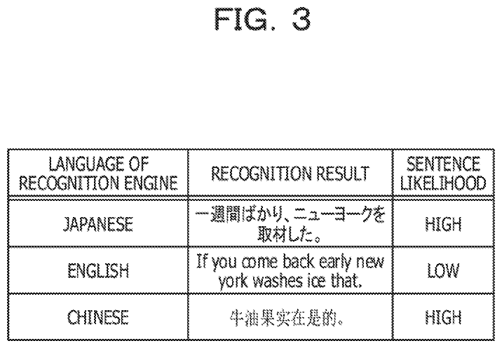

FIGS. 2 and 3 illustrate a case where such an erroneous identification may occur. FIG. 2 is a diagram illustrating an example of a speech recognition result, and FIG. 3 is a diagram illustrating an example of sentence likelihoods. FIG. 2 illustrates speech recognition results 22 to 24 in the case where speech recognition engines supporting three languages of Japanese, English, and Chinese are applied to a Japanese speech 21. The three speech recognition results 22 to 24 present phoneme strings expressed by phoneme symbols in accordance with the International Phonetic Alphabet (IPA). Furthermore, the speech recognition results 23 and 24 present Japanese texts to which the speech 21 is translated from the English text and Chinese text. FIG. 3 illustrates the sentence likelihood together with the speech recognition result for the speech 21 illustrated in FIG. 2 for each of the languages supported by the respective speech recognition engines.

As illustrated in FIG. 2, when a speech recognition engine for Japanese is applied to the Japanese speech 21 “I collected information in New York for around one week” (step S1-1), the speech recognition result 22 is obtained. Then, a likelihood that the speech recognition result 22 is a Japanese sentence is calculated by way of matching of the speech recognition result 22 with the linguistic model and the acoustic model of Japanese. In this case, since the language “Japanese” used in the speech 21 and the language “Japanese” supported by the speech recognition engine are the same, the speech recognition result 22 identical to the speech 21 is obtained. As illustrated in FIG. 3, the sentence likelihood for Japanese calculated from the speech recognition result 22 is highly likely to be higher than the sentence likelihoods for the other foreign languages calculated from the speech recognition results obtained by applying the speech recognition engines for the foreign languages different from the language in the speech 21.

When a speech recognition engine for English is applied to the Japanese speech 21 “I collected information in New York for around one week” (step S1-2), the speech recognition result 23 is obtained. Then, a likelihood that the speech recognition result 23 is an English sentence is calculated by way of matching of the speech recognition result 23 with the linguistic model and the acoustic model of English. In this case, since the language “Japanese” used in the speech 21 and the language “English” supported by the speech recognition engine are not the same, the sentence likelihood for English calculated from the speech recognition result 23 is lower than the sentence likelihood for Japanese calculated from the speech recognition result 22, as illustrated in FIG. 3.

When a speech recognition engine for Chinese is applied to the Japanese speech 21 “I collected information in New York for around one week” (step S1-3), the speech recognition result 24 is obtained. Then, a likelihood that the speech recognition result 24 is a Chinese sentence is calculated by way of matching of the speech recognition result 24 with the linguistic model and the acoustic model of Chinese. In this case, the language “Japanese” used in the speech 21 and the language “Chinese” supported by the speech recognition engine are not the same. Nevertheless, in some cases, the sentence likelihood for Chinese calculated from the speech recognition result 24 is higher relatively than the sentence likelihood for English calculated from the speech recognition result 23, and takes a value dose to the value of the sentence likelihood for Japanese calculated from the speech recognition result 22 as illustrated in FIG. 3.

In this manner, when the speech 21 that may possibly be matched Japanese and Chinese in terms of both the linguistic features and the acoustic features is input as a voice, a situation may occur in which the type of language in the speech 21 is erroneously identified as Chinese.

[One Aspect of Approach to Solve the Problem]

From the viewpoint of reducing such erroneous identifications, the speech translation server 10 according to this embodiment is provided with a language identification function which calculates a phoneme count (the number of phonemes) in a speech recognition result obtained by performing speech recognition on an input voice for each of multiple languages, and identifies the type of language matched with the input voice based on the phoneme counts counted for the respective languages.

In one aspect, the motivation to identify a language based on the phoneme counts may be established with knowledge that the phoneme count in a speech recognition result is different between the speech recognition for the same language as the input voice and the speech recognition for a language different from the input voice.

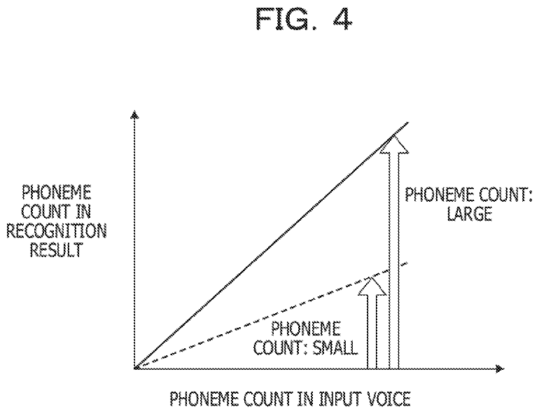

FIG. 4 is a diagram illustrating an example of a graph relating to the phoneme count. The vertical axis of the graph illustrated in FIG. 4 indicates the phoneme count in the text of a speech recognition result, while the horizontal axis of the graph indicates the phoneme count in the input voice. Furthermore, in FIG. 4, the phoneme count in a result of speech recognition performed by a speech recognition engine for the same language as the input voice is indicated by a solid line, while the phoneme count in a result of speech recognition performed by a speech recognition engine for a language different from the input voice is indicated by a broken line. As illustrated in FIG. 4, it is understood that the phoneme count in the case where the speech recognition is performed by the speech recognition engine for the same language as the input voice is steadily larger than that in the case where the speech recognition is performed by the speech recognition engine for the language different from the input voice.

One of the reasons why the relationship between the phoneme counts is established is that when speech recognition is performed by a speech recognition engine for a language different from the input voice, there is a high possibility of phoneme recognition failure because the input voice contains phonemes which are not registered from the beginning or have low existence probability in the acoustic model used for speech recognition.

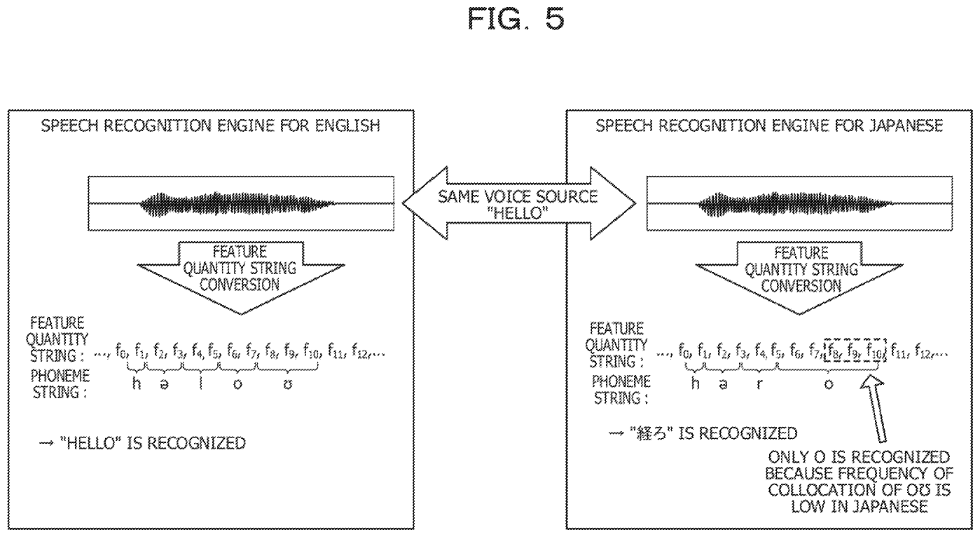

FIG. 5 is a diagram illustrating an example of comparison between identification results of phonemes. FIG. 5 illustrates how the speech recognition engines operate in the case where an English speech “Hello” is input as a voice. The left side of FIG. 5 presents an example where a speech recognition engine, the supported language of which is English, identifies phonemes by using the English acoustic model, whereas the right side of FIG. 5 presents an example where a speech recognition engine, the supported language of which is Japanese, identifies phonemes by using the Japanese acoustic model.

As illustrated in FIG. 5, when voice data of the English speech “Hello” is input to the English speech recognition engine and the Japanese speech recognition engine, each speech recognition engine converts the frames included in the voice data into time-series data of feature quantities such as Mel-Frequency Cepstrum Coeffidents (MFCC). Hereinafter, the time-series data of the feature quantities are referred to as a “feature quantity string” in some cases. In the example Illustrated in FIG. 5, the waveform of the voice data is converted into a feature quantity string including f₀, f₁, . . . , f₁₂.

Thereafter, each of the speech recognition engines performs matching of the feature quantity string f₀, f₁, . . . , f₁₂ with a phoneme acoustic model in which each phoneme existing in the language and a distribution of the existence probability of the feature quantity of the phoneme are modeled, and thereby allocates phonemes having feature quantities dose to the feature quantity string f₀, f₁, . . . , f₁₂. Furthermore, the speech recognition engine performs matching of the phonemes allocated using the phoneme acoustic model with a word acoustic model in which the existence probability of a combination of each phoneme string and the corresponding English word are modeled, and thereby allocates the word to the phonemes allocated by using the phoneme acoustic model. Furthermore, the speech recognition engine performs matching of a word string allocated using the word acoustic model with a linguistic model in which the existence probability of each word order is defined, and thereby evaluates the word order by a score such as a likelihood. These series of matching is dynamically executed according to the Hidden Markov Model (HMM), so that text associated with the word string having the highest evaluation score is output as a speech recognition result.

In such dynamic matching, the phoneme count in the speech recognition result varies depending on whether the language supported by the speech recognition engine is the same as the language used in the speech of the input voice.

For example, in the English speech recognition engine, the phoneme “h” is allocated to the feature quantity f₁, the phoneme “ [symbol] ” is allocated to the feature quantities f₂ and f₃, the phoneme “I” is allocated to the feature quantities f₄ and f₅, the phoneme “o” is allocated to the feature quantities f₆ and f₇, and the phoneme “ [symbol] ” is allocated to the feature quantities f₈ to f₁₀ in the feature quantity string f₀, f₁, . . . , f₁₂.

On the other hand, in the Japanese speech recognition engine, the phoneme “h” is allocated to the feature quantity f₁, the phoneme “ [symbol] ” is allocated to the feature quantities f₂ and f₃, the phoneme “r” is allocated to the feature quantities f₄ and f₅, and the phoneme “o” is allocated to the feature quantities f₆ to f₁₀ in the feature quantity string f₀, f₁, . . . , f₁₂.

As described above, in the English word acoustic model, the frequency of the sequence of the phoneme “o” and the phoneme “ [symbol] ” is high, so that the phoneme “o” is allocated to the feature quantities f₆ and f₇ and the phoneme “ [symbol] ” is allocated to the feature quantities f₈ to f₁₀, successfully. As a result of allocation of these phonemes, the English speech recognition engine is able to output a correct speech recognition result of “Hello”. On the other hand, in the Japanese acoustic model, the frequency of the sequence of the phoneme “o” and the phoneme “ [symbol] ” is low, so that the single phoneme “o” is allocated to the feature quantities f₆ to f₁₀ and the recognition of the phoneme “ [symbol] ” is failed. Due to the recognition failure of the phoneme “ [symbol] ”, the Japanese speech recognition engine outputs an erroneous speech recognition result of “pass”.

Therefore, it is apparent that the phoneme count in the case of speech recognition performed by a speech recognition engine for the same language as an input voice is larger than in the case of speech recognition performed by a speech recognition engine for a language different from the input voice.

Thus, the language identification based on the phoneme counts is also able to correctly identify the language used in the Japanese speech 21 “I collected information in New York for around one week” illustrated in FIG. 2.

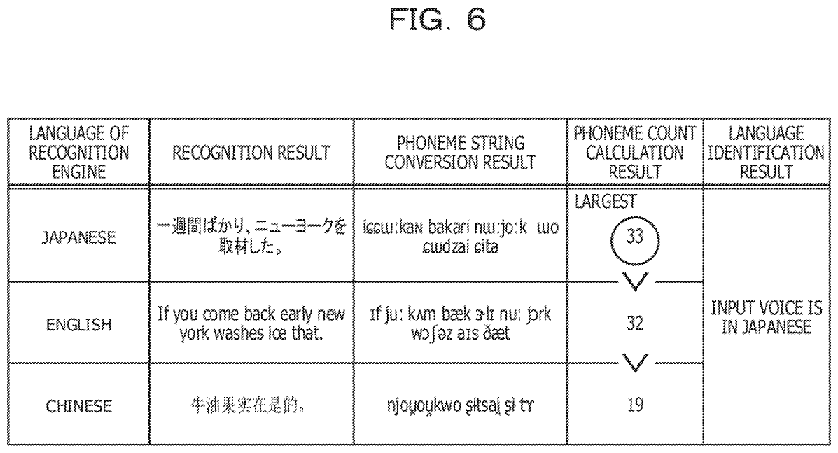

FIG. 6 is a diagram Illustrating an example of the phoneme counts obtained by the respective speech recognition results. In the table illustrated in FIG. 6, the conversion result of the phoneme string and the calculation result of the phoneme count are presented for each of the speech recognition results 22 to 24 in the case where the speech recognition engines for the three languages, for example, Japanese, English, and Chinese are applied to the speech 21 in FIG. 2. As presented in FIG. 6, the phoneme count in the speech recognition result 22 output from the Japanese speech recognition engine is “33”, the phoneme count in the speech recognition result 23 output from the English speech recognition engine is “32”, and the phoneme count in the speech recognition result 24 output from the Chinese speech recognition engine is “19”. For example, the type of language matched with the speech 21 is identified as the correct language, that is, Japanese by checking a magnitude relationship among the three phoneme counts by comparison.

Therefore, according to the speech translation server 10 of the present embodiment, it is possible to improve the accuracy in identification of a type of a language.

[Configuration of Speech Translation Server 10]

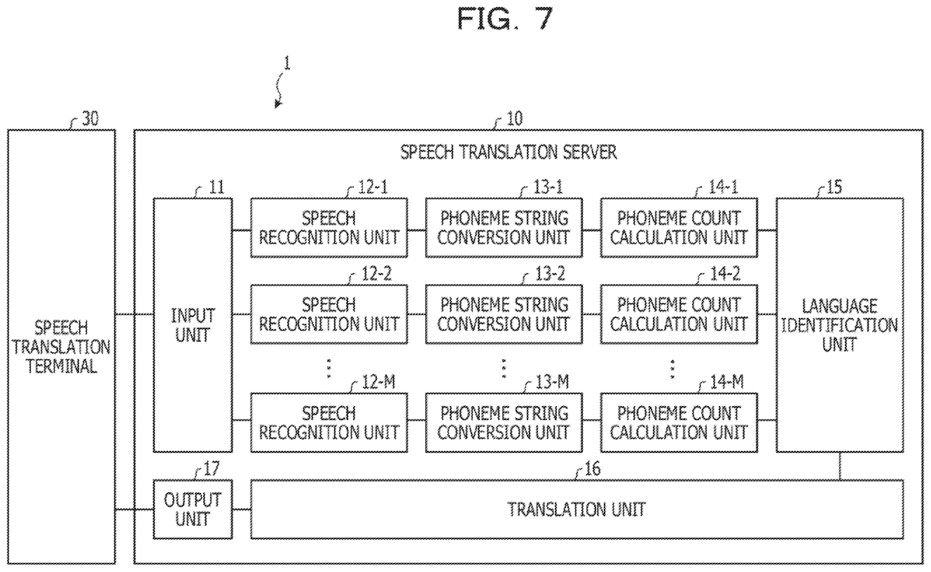

FIG. 7 is a block diagram illustrating an example of a functional configuration of the speech translation server 10 according to Embodiment 1. As illustrated in FIG. 7, the speech translation server 10 includes an input unit 11, speech recognition units 12-1 to 12-M, phoneme string conversion units 13-1 to 13-M, phoneme count calculation units 14-1 to 14-M, a language identification unit 15, a speech translation unit 16, and an output unit 17. Note that the speech translation server 10 may include various functional units included in a known computer other than the functional units illustrated in FIG. 7, such as a communication interface that controls communication with other devices.

The functional units such as the input unit 11, the speech recognition units 12-1 to 12-M, the phoneme string conversion units 13-1 to 13-M, the phoneme count calculation units 14-1 to 14-M, the language identification unit 15, the speech translation unit 16, and the output unit 17 illustrated in FIG. 7 are virtually implemented by a hardware processor such as a central processing unit (CPU) or a micro processing unit (MPU).

For example, the processor reads a speech translation program in addition to operating system (OS) from a storage device not illustrated, such as a hard disk drive (HDD), an optical disk, or a solid state drive (SSD). Then, the processor executes the speech translation program to load a process to serve as the aforementioned functional units onto a memory such as a random-access memory (RAM). As a result, the functional units are virtually Implemented as the process.

Although the example where the speech translation program in which the functions for the speech translation service are packaged is executed is described here, program modules in units such as the aforementioned language identification function may be executed.

In addition, although the CPU and the MPU are exemplified as one example of the processor here, the functional units described above may be implemented by any processor regardless of whether the processor is a general-purpose type or a special type. In addition, the functional units described above may be implemented by a hard wired logic circuit such as an application specific integrated circuit (ASIC) or a field-programmable gate array (FPGA).

The input unit 11 is a processing unit that controls input of information for the functional units in the subsequent stages.

In one aspect, when the voice data of a speech segment is received as a speech translation request from the speech translation terminal 30, the input unit 11 inputs the voice data of the speech segment for each of M systems corresponding to the number M (M is a natural number) of languages to be identified. In the following, each of the first to M-th systems is identified with the number corresponding to the respective systems which is added as suffixes to the reference numerals of the speech recognition units, the phoneme string conversion units, and the phoneme count calculation units, and the M systems are represented by using an index k (=1 to M) in some cases. In addition, the language of the first system is referred to as a “first language”, the language of the second system is referred to as a “second language”, and the language of the k-th system is referred to as a “k-th language” in some cases.

The speech recognition units 12-1 to 12-M are processing units each of which executes speech recognition. Hereinafter, the speech recognition units 12-1 to 12-M are collectively referred to as the “speech recognition unit 12” In some cases.

In one embodiment, the speech recognition unit 12 may be implemented by executing a speech recognition engine for a language allocated to the system. For example, it is assumed that Japanese is allocated to the first system, English is allocated to the second system, and Chinese is allocated to the third system. In this case, to the voice data of the speech segment output from the input unit 11, the speech recognition unit 12-1 applies the speech recognition engine for Japanese, the speech recognition unit 12-2 applies the speech recognition engine for English, and the speech recognition unit 12-3 applies the speech recognition engine for Chinese. These speech recognition engines may be of general use.

The phoneme string conversion units 13-1 to 13-M are processing units each of which converts the speech recognition result into a phoneme string. Hereinafter, the phoneme string conversion units 13-1 to 13-M are collectively referred to as the “phoneme string conversion unit 13” in some cases.

In one embodiment, the phoneme string conversion unit 13 converts the speech text obtained as a speech recognition result by the speech recognition unit 12 into a phoneme string expressed by phoneme symbols in accordance with the IPA. For example, the phoneme string conversion unit 13 identifies the phonemes by performing maximum likelihood estimation, Bayesian inference, or the like on the speech text output from the speech recognition unit 12 by using the N-gram statistical data and the associated phoneme information. Note that although IPA is cited as an example of the phoneme symbols here, the phoneme string may be expressed by other phoneme symbols. In this embodiment, the speech text is converted into the time-series data of phonemes. However, the speech text does not necessarily have to be converted into the time-series data of phonemes, but may be converted into a vector string including the feature quantities and likelihoods of phonemes.

The phoneme count calculation units 14-1 to 14-M are processing units each of which calculates the phoneme count from the phoneme string. Hereinafter, the phoneme count calculation units 14-1 to 14-M are collectively referred to as the “phoneme count calculation unit 14” in some cases.

In one embodiment, the phoneme count calculation unit 14 counts the number of phonemes contained in the phoneme string converted from the speech text by the phoneme string conversion unit 13, thereby calculating the phoneme count in the speech recognition result output from the speech recognition engine of the system. Alternatively, the phoneme count calculation unit 14 may weight each phoneme contained in the phoneme string and calculate the sum of the weights as the phoneme count in accordance with the following equation (1). In this case, the phoneme count calculation unit 14 may assign a higher weight to a phoneme to be used uniquely at a higher degree or a phoneme having a higher uniqueness in the language of the system. For example, the weight assigned to each phoneme may be the reciprocal of the existence probability of the phoneme calculated statistically from learning data including a large number of learning samples. In the following equation (1), “P_{k,i}” denotes a phoneme (or a character) appearing in the speech recognition result of the k-th language, and, for example, is expressed as P_{k,1}, P_{k,2}, . . . , P_{k,nk}. Also, “i” denotes an index that identifies the place in the order of n phonemes contained in a phoneme string. In the following equation (1), “nₖ” denotes the phoneme count in the speech recognition result for the k-th language. In addition, “W_{L,k} (P_{k,i})” in the following equation (1) denotes a weight to be assigned to a phoneme.

$$PHONEME COUNT = {\sum }_{i = 1}^{{n}_{k} - 1} {W}_{P , k} ( {p}_{k , i} ) \qquad ( 1 )$$

When a vector string is used instead of a phoneme string, each of scores of phonemes may be calculated from information included in the vector, and the sum of the scores may be used. Instead, the phoneme count in the system having the largest phoneme count in the phoneme string may be used to normalize the phoneme counts obtained by the other systems.

The language identification unit 15 is a processing unit that identifies the type of language based on the phoneme counts calculated for the respective systems.

In one embodiment, the language identification unit 15 identifies, as a language used in the speech, the language having the largest phoneme count among the phoneme counts calculated for the respective systems of the phoneme count calculation units 14-1 to 14-M, for example, for the respective first to M-th languages. Hereinafter, the language used in the speech identified by the language identification unit 15 is referred to as the “speech language”.

The speech translation unit 16 is a processing unit that performs speech translation on the speech recognition result in the speech language.

Here, as just an example, a description is given of a case where speech translation of speeches of the medical personnel 3A and the foreign patient 3B is performed at the medical site illustrated in FIG. 1. For example, when the speech language identified by the language identification unit 15 is a foreign language other than Japanese, the speech translation unit 16 executes machine translation for converting the speech text for the speech language into a translated text for Japanese. When the speech language identified by the language identification unit 15 is Japanese, the speech translation unit 16 executes machine translation for converting the speech text for the speech language into a translated text for the language identified immediately before as the foreign language by the language identification unit 15.

The output unit 17 is a processing unit that controls output to the speech translation terminal 30.

In one aspect, the output unit 17 generates, from the translated text generated by the speech translation unit 16, a synthesized voice for reading aloud the translated text. Then, the output unit 17 outputs the voice data of the synthesized voice for reading aloud the translated text to the speech translation terminal 30 which has made a speech translation request by transmitting the voice data of the speech segment.

[Processing Sequence]

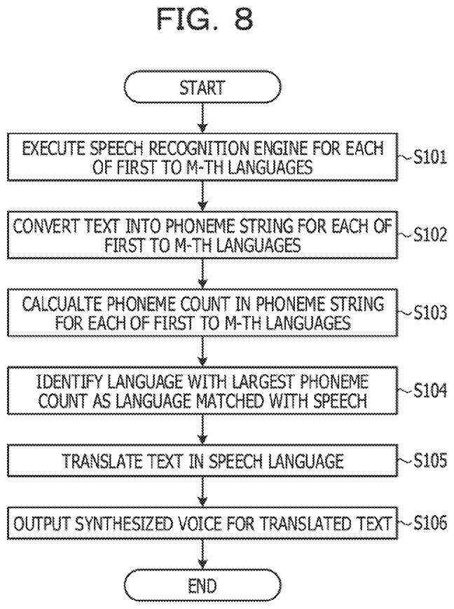

FIG. 8 is a flowchart illustrating a procedure of speech translation processing according to Embodiment 1. By way of example only, this processing is started when the voice data of a speech segment is received as a speech translation request from the speech translation terminal 30.

As illustrated in FIG. 8, the speech recognition units 12-1 to 12-M input the voice data of the speech segment to the speech recognition engines for the languages allocated to the respective systems, thereby performing speech recognition for the respective systems of the speech recognition units 12-1 to 12-M, for example, for the respective first to M-th languages (step S101).

Subsequently, the phoneme string conversion units 13-1 to 13-M convert the speech texts obtained as the speech recognition results by the speech recognition units 12-1 to 12-M into phoneme strings expressed by phoneme symbols in accordance with the IPA (step S102).

The phoneme count calculation units 14-1 to 14-M calculate the phoneme counts in the phoneme strings converted from the speech texts by the phoneme string conversion units 13-1 to 13-M (step S103). By the processing from step S101 to step S103, the phoneme count is calculated for each of the first to M-th languages.

Thereafter, the language identification unit 15 identifies, as a speech language, the language having the largest phoneme count among the phoneme counts calculated for the respective systems of the phoneme count calculation units 14-1 to 14-M, for example, for the respective first to M-th languages (step S104).

Then, the speech translation unit 16 converts the speech text for the speech language identified in step S104 into the translated text for Japanese or the foreign language (step S105). Subsequently, the output unit 17 generates, from the translated text obtained in step S105, a synthesized voice for reading aloud the translated text, outputs the voice data of the synthesized voice to the speech translation terminal 30 (step S106), and terminates the processing.

[One Aspect of Effects]

As described above, the speech translation server 10 of the present embodiment enables the identification of the type of language in a hands-free manner. In addition, it is also possible to improve the accuracy in identification of a type of a language as compared with the aforementioned language identification system.

### Embodiment 2

In Embodiment 1 described above, the example in which the speech language is identified based on the phoneme count is described, but it is also possible to identify the type of speech language by additionally using other information. In this embodiment, a description is given of an example in which the type of speech language is identified based on the sentence likelihood of the speech in addition to the phoneme count.

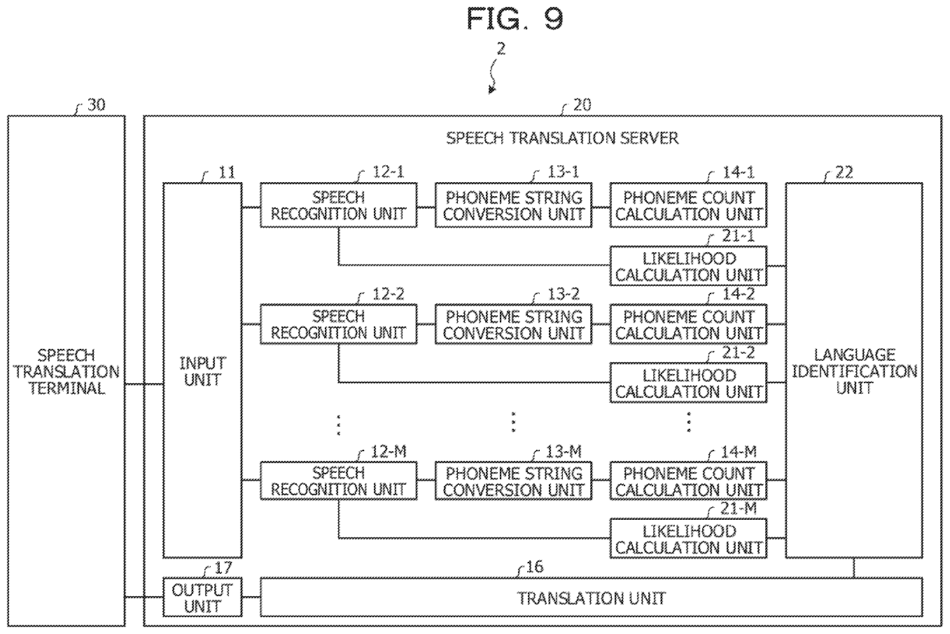

FIG. 9 is a block diagram illustrating an example of a functional configuration of a speech translation server 20 according to Embodiment 2. The speech translation server 20 illustrated in FIG. 9 is different from the speech translation server 10 illustrated in FIG. 7 in that it further includes likelihood calculation units 21-1 to 21-M. Furthermore, the speech translation server 20 illustrated in FIG. 9 is different from the speech translation server 10 illustrated in FIG. 7 in that it further includes a language identification unit 22, the processing details of which are partly different from those of the language identification unit 15. In FIG. 9, the same reference numerals are given to the functional units having the same functions as those of the speech translation server 10 illustrated in FIG. 7, and a description thereof is not repeated herein.

The likelihood calculation units 21-1 to 21-M are processing units which calculate the sentence likelihoods of the speech recognition results obtained by the speech recognition units 12-1 to 12-M. Here, as an example, the technique described in Non Patent Literature: J. L. Hieronymus and S. Kadambe, “Robust spoken language identification using large vocabulary speech recognition”, 1997 IEEE International Conference on Acoustics, Speech, and Signal Processing may be used to calculate the sentence likelihood.

In one embodiment, the likelihood calculation units 21-1 to 21-M calculate the sentence likelihoods for the respective systems of the speech recognition units 12-1 to 12-M, for example, for the respective first to M-th languages, based on the linguistic models from the speech texts output from the speech recognition units 12-1 to 12-M according to the following equation (2). In the following expression (2), “l_{k,s}” denotes the sentence likelihood of the k-th language for the speech text. In the following expression (2), “w_{k,i}” denotes a word (or a character) appearing in the speech recognition result for the k-th language, and, for example, is expressed as w_{k,1}, w_{k,2}, . . . , w_{k,nk}. Further, “i” denotes an index that identifies the place in the order of Nₖ words contained in a word string of the speech recognition result for the k-th language. In addition, “Pₖ(w_{k,i+1}|w_{k,i})” in the following equation (2) denotes a linguistic model.

$${l}_{k , s} = \frac{1}{{N}_{k}} {log}_{10} {\prod }_{i = 1}^{{N}_{k} - 1} {P}_{k} ( {w}_{k , i + 1} \vert {w}_{k , i} ) \qquad ( 2 )$$

The language identification unit 22 identifies the type of speech language based on the phoneme counts calculated for and the sentence likelihoods based on the linguistic models for the respective systems of the phoneme count calculation units 14-1 to 14-M, for example, for the respective first to M-th languages. For example, the language identification unit 22 narrows down the first to M-th languages to languages each having a sentence likelihood exceeding a predetermined threshold value T₁. As an example, the threshold value T₁ may be set to half of the minimum likelihood of the linguistic model or larger. For example, if the minimum likelihood (log) is −10.0 (a probability of 0.00000001%), the threshold value T₁ may be set to −5.0. In this manner, after narrowing down to the languages each having the sentence likelihood exceeding the threshold value T₁, the language identification unit 22 identifies, as the language used in the speech, the language having the largest phoneme count among the narrowed languages.

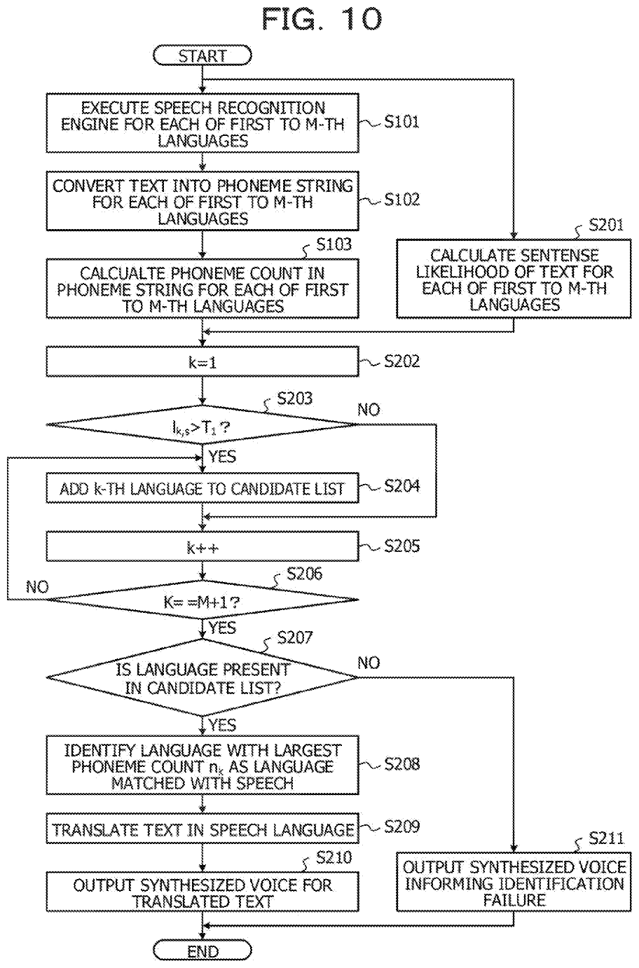

FIG. 10 is a flowchart illustrating a procedure of speech translation processing according to Embodiment 2. By way of an example only, the processing is started when the voice data of a speech segment is received as a speech translation request from the speech translation terminal 30.

As Illustrated in FIG. 10, the speech recognition units 12-1 to 12-M input the voice data of the speech segment to the speech recognition engines for the respective languages allocated to the systems, thereby performing speech recognition for the respective systems of the speech recognition units 12-1 to 12-M, for example, for the respective first to M-th languages (step S101).

Subsequently, the phoneme string conversion units 13-1 to 13-M convert the speech texts obtained as the speech recognition results by the speech recognition units 12-1 to 12-M into phoneme strings expressed by phoneme symbols in accordance with the IPA (step S102).

The phoneme count calculation units 14-1 to 14-M calculate the phoneme counts in the phoneme strings converted from the speech texts by the phoneme string conversion units 13-1 to 13-M (step S103). By the processing from step S101 to step S103, the phoneme count is calculated for each of the first to M-th languages.

At the same time or in parallel with the processing from step S101 to step S103, the likelihood calculation units 21-1 to 21-M calculate the sentence likelihoods for the respective first to M-th languages based on the linguistic models from the speech texts output by the speech recognition units 12-1 to 12-M (step S201).

Then, the language identification unit 22 initializes the index k for identifying the language supported by each system to a predetermined initial value, for example, “1” (step S202). Subsequently, the language identification unit 22 determines whether or not the sentence likelihood l_{k,s} for the index k exceeds the threshold value T₁ (step S203).

In this step, when the sentence likelihood l_{k,s} exceeds the threshold value T₁ (Yes in step S203), the language identification unit 22 adds the k-th language to a candidate list held in an internal memory (not illustrated) (step S204). Meanwhile, when the sentence likelihood l_{k,s} does not exceed the threshold value T₁ (No in step S203), the processing in step S204 is skipped.

Thereafter, the language identification unit 22 increments the index k by one (step S205). Subsequently, the language identification unit 22 determines whether or not the value of the index k becomes M+1, for example, whether or not the value exceeds the number M of languages supported by the systems (step S206).

Then, the processing from step S203 to step S205 is repeatedly executed until the value of the index k becomes M+1 (No in step S206). After that, when the value of the index k becomes M+1 (Yes in step S206), the language identification unit 22 determines whether or not the languages exist in the candidate list (step S207).

Here, when the languages exist in the candidate list (Yes in step S207), the language identification unit 15 identifies, as the speech language, the language having the largest phoneme count among the languages existing in the candidate list stored in the internal memory (step S208).

Then, the speech translation unit 16 converts the speech text for the speech language identified in step S208 into a translated text for Japanese or the foreign language (step S209). Subsequently, the output unit 17 generates, from the translated text obtained in step S209, a synthesized voice for reading aloud the translated text, outputs the voice data of the synthesized voice to the speech translation terminal 30 (step S210), and terminates the processing.

When no language exists in the candidate list (No in step S207), the output unit 17 generates a synthesized voice informing an identification failure in Japanese and English, outputs the voice data of the synthesized voice to the speech translation terminal 30 (step S211), and terminates the processing.

As described above, the speech translation server 20 of the present embodiment enables the identification of the type of language in a hands-free manner, as in the case of Embodiment 1 described above.

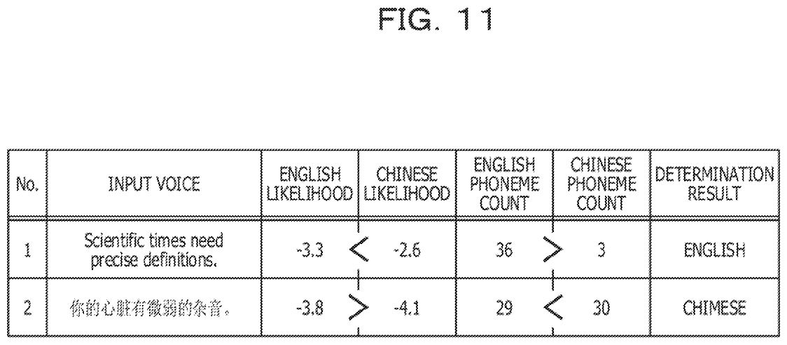

Further, in the speech translation server 20 according to the present embodiment, it is also possible to improve the accuracy in identification of a type of a language, as compared with the language identification system described above. FIG. 11 is a diagram illustrating an example of language identification results of an input voice. Regarding two speeches Nos. 1 and 2, FIG. 11 presents the sentence likelihood for English, the sentence likelihood for Chinese, the phoneme count in the speech recognition result by the English speech recognition engine, the phoneme count in the speech recognition result by the Chinese speech recognition engine, and the identification result.

In the example of the speech No. 1 illustrated in FIG. 11, if the type of language is identified only based on the sentence likelihood, the English speech is erroneously recognized as the Chinese speech because the sentence likelihood for Chinese is higher than the sentence likelihood for English. On the other hand, if the type of language is identified using the phoneme count, the language used in the speech No. 1 is correctly identified as English because the phoneme count in the speech recognition result by the English speech recognition engine is larger than the phoneme count in the speech recognition result by the Chinese speech recognition engine.

Further, in the example of the speech No. 2 illustrated in FIG. 11, if the type of language is identified only based on the sentence likelihood, the Chinese speech is erroneously recognized as the English speech because the sentence likelihood for English is higher than the sentence likelihood for Chinese. On the other hand, if the type of language is identified using the phoneme count, the language used in the speech No. 2 is correctly identified as Chinese because the phoneme count in the speech recognition result by the Chinese speech recognition engine is larger than the phoneme count in the speech recognition result by the English speech recognition engine.

In addition, since the speech translation server 20 according to the present embodiment uses the sentence likelihoods of a speech in addition to the phoneme counts for identification of the type of speech language, it is also possible to further improve the accuracy in identification of a type of a language as compared with the speech translation server 10 according to Embodiment 1.

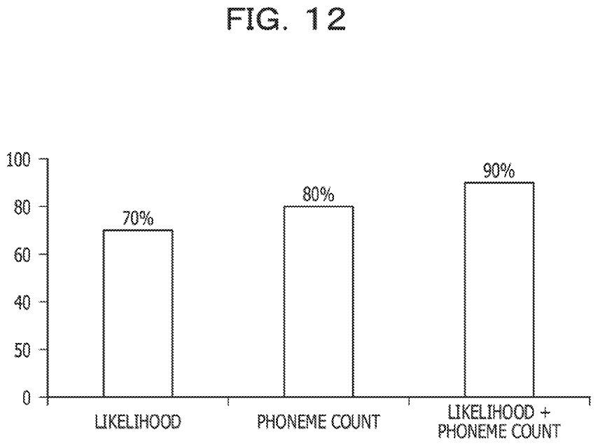

FIG. 12 is a diagram illustrating an example of a correct rate according to the language identification method. FIG. 12 presents correct rates for each of three language identification methods in language type identification using the English and Chinese speech recognition engines and totally ten voice sources including five English speeches and five Chinese speeches input as input voices. FIG. 12 presents, in order from the left, a correct rate of “70%” in the case where the type of language is identified using only the sentence likelihood, a correct rate of “80%” in the case where the type of language is identified using only the phoneme count, and a correct rate of “90%” in the case where the type of language is identified by using the sentence likelihood and the phoneme count. Thus, it is seen that the correct rate is higher when the phoneme count is used than when the sentence likelihood is used, and that the correct rate is the highest when both the sentence likelihood and the phoneme count are used.

### Embodiment 3

Heretofore, the embodiments of the devices of the present disclosure have been described. It is to be understood that embodiments of the present disclosure may be made in various ways other than the aforementioned embodiments. Therefore, other embodiments included in the present disclosure are described below.

[Total Score Calculation]

In Embodiment 2 described above, the example is described in which the languages are narrowed down to the languages having the sentence likelihood exceeding the threshold value T₁, and then the language having the largest phoneme count is identified as a speech language from among the languages having the sentence likelihoods exceeding the threshold value T₁, but the way to use the sentence likelihoods is not necessarily limited to this. For example, it is also possible to calculate the total score of the sentence likelihood and the phoneme count in accordance with the following equation (3), and to identify the language whose total score is the highest as the speech language. In the following equation (3), “S_{k,s}” denotes the total score of the sentence likelihood and the phoneme count. In the following equation (3), “w_{k,l}” denotes a word (or a character) appearing in the speech recognition result for the k-th language, and, for example, is expressed as w_{k,1}, w_{k,2}, . . . , w_{k,nk}. In the following equation (3), “nₖ” denotes the phoneme count in the speech recognition result for the k-th language. In the following equation (3), “l_{k,s}” denotes the sentence likelihood of the k-th language for the speech text, and may be calculated by, for example, the above equation (2).

S_{k,s}=nₖ|kₛ (3)

[Buffering of Identification Results]

For example, the speech translation server 10 or 20 may store a history of language identification results of the language identification unit 15 or the language identification unit 22 in a storage area such as a buffer. For example, the history of the language identification results may be deleted from the old information when ten or more results of speeches are accumulated. If no speech is given for a certain period of time, the history may be initialized. In addition, the history of the language identification results may be used as follows. Specifically, after the language having the largest phoneme count is selected, an erroneous identification probability of the identification result is evaluated by referring to the buffer in which the history of the language identification results are stored, and the language identification may be corrected based on majority rule, Bayesian inference, or the like using the identification results in the buffer.

[Stand-Alone]

The above Embodiments 1 and 2 describe the example in which the speech translation server 10 or the speech translation server 20 and the speech translation terminal 30 are constructed as a client server system, but the speech translation service described above may be provided solely by the speech translation terminal 30. In this case, the speech translation terminal 30 may be provided with the functional units included in the speech translation server 10 or the speech translation server 20, and may not necessarily be coupled to the network.

[Separation and Integration]

The components illustrated in the drawings do not necessarily have to be physically configured as illustrated in the drawings. Specific forms of the separation and integration of the devices are not limited to the illustrated forms, and all or a portion thereof may be separated and integrated in any units in either a functional or physical manner depending on various conditions such as a load and a usage state. For example, in an example of the speech translation server 10, the input unit 11, the speech recognition units 12-1 to 12-M, the phoneme string conversion units 13-1 to 13-M, the phoneme count calculation units 14-1 to 14-M, the language identification unit 15, the speech translation unit 16, or the output unit 17 may be coupled as an external device to the speech translation server 10 via a network. In an example of the speech translation server 10, the input unit 11, the speech recognition units 12-1 to 12-M, the phoneme string conversion units 13-1 to 13-M, the phoneme count calculation units 14-1 to 14-M, the language identification unit 15, the speech translation unit 16, and the output unit 17 may be included in respective different devices, and implement the functions of the speech translation server 10 by collaborating with each other through a network communication. Further, in an example of the speech translation server 20, the input unit 11, the speech recognition units 12-1 to 12-M, the phoneme string conversion units 13-1 to 13-M, the phoneme count calculation units 14-1 to 14-M, the speech translation unit 16, the output unit 17, the likelihood calculation units 21-1 to 21-M, or the language identification unit 22 may be coupled as an external device to the speech translation server 20 via a network. Further, in an example of the speech translation server 20, the function of the input unit 11, the speech recognition units 12-1 to 12-M, the phoneme string conversion units 13-1 to 13-M, the phoneme count calculation units 14-1 to 14-M, the speech translation unit 16, the output unit 17, the likelihood calculation units 21-1 to 21-M, and the language identification unit 22 may be included in respective different devices, and implement the functions of the speech translation server 20 by collaborating with each other through a network communication.

[Language Identification Program]

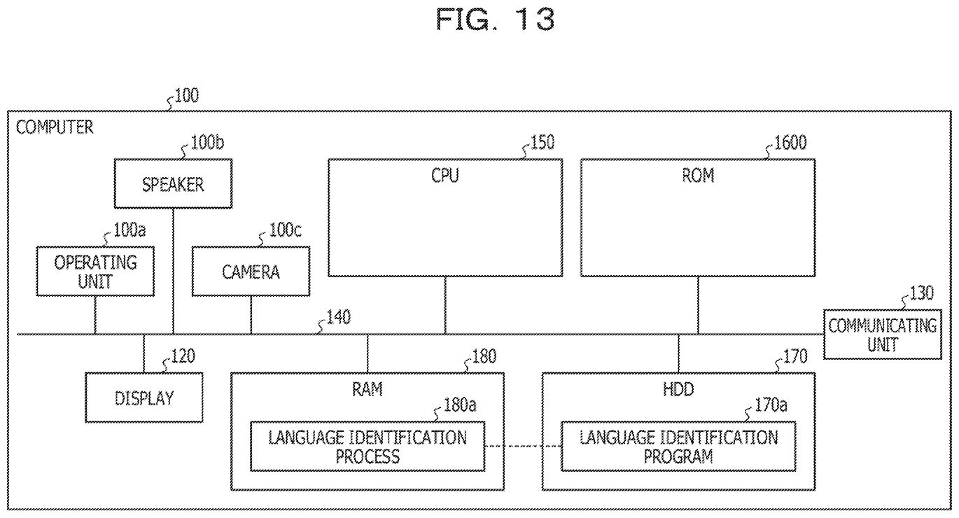

The various kinds of processing described in the above embodiments may be implemented by executing a program prepared in advance on a computer such as a personal computer or a work station. In the following, with reference to FIG. 13, a description is given of an example of a computer for executing a language identification program having the same functions as those of the above-described embodiments.

FIG. 13 is a diagram illustrating an example of a hardware configuration of a computer executing the language identification program according to Embodiments 1 to 2. As illustrated in FIG. 13, the computer 100 includes an operation unit 110a, a speaker 110b, a camera 110c, a display 120, and a communication unit 130. Further, the computer 100 includes a CPU 150, a ROM 160, an HDD 170, and a RAM 180. These units 110 to 180 are coupled to each other via a bus 140.

The HDD 170 stores a language identification program 170a that exerts the same functions as those of the input unit 11, the speech recognition units 12-1 to 12-M, the phoneme string conversion units 13-1 to 13-M, the phoneme count calculation units 14-1 to 14-M, the language identification unit 15, the speech translation unit 16, and the output unit 17, which are described above in Embodiment 1. The language identification program 170a may be integrated or separated in the same manner as the components such as the input unit 11, the speech recognition units 12-1 to 12-M, the phoneme string conversion units 13-1 to 13-M, the phoneme count calculation units 14-1 to 14-M, the language identification unit 15, the speech translation unit 16, and the output unit 17 illustrated in FIG. 7. For example, the HDD 170 may not necessarily store all of the data described in Embodiment 1, but may store only data for use in the processing.

The HDD 170 may store a language identification program 170a that exerts the same functions as those of the input unit 11, the speech recognition units 12-1 to 12-M, the phoneme string conversion units 13-1 to 13-M, the phoneme count calculation units 14-1 to 14-M, the speech translation unit 16, the output unit 17, the likelihood calculation units 21-1 to 21-M, and the language identification unit 22, which are described above in Embodiment 2. The language identification program 170a may be integrated or separated in the same manner as the components such as the input unit 11, the speech recognition units 12-1 to 12-M, the phoneme string conversion units 13-1 to 13-M, the phoneme count calculation units 14-1 to 14-M, the speech translation unit 16, the output unit 17, the likelihood calculation units 21-1 to 21-M, and the language identification unit 22 illustrated in FIG. 9. For example, the HDD 170 may not necessarily store all of the data described in Embodiment 2, but may store only data for use in the processing.

Under such an environment, the CPU 150 loads the language identification program 170a from the HDD 170 into the RAM 180. As a result, as illustrated in FIG. 13, the language identification program 170a functions as a language identification process 180a. The language identification process 180a unarchives various kinds of data read from the HDD 170 in an area allocated to the language identification process 180a in the storage area included in the RAM 180, and executes various kinds of processing using these various kinds of data thus unarchived. For example, an example of the processing performed by the language identification process 180a includes the processing illustrated in FIG. 8 or 10. Not all the processing units described in above Embodiment 1 necessarily have to operate on the CPU 150, but only a processing unit(s) corresponding to the processing to be executed may be virtually implemented.

The language identification program 170a does not necessarily have to be initially stored in the HDD 170 or the ROM 160. For example, the language identification program 170a is stored in a “portable physical medium” such as a flexible disk called an FD, a CD-ROM, a DVD disk, a magneto-optical disk, or an IC card, which will be inserted into the computer 100. Then, the computer 100 may acquire the language identification program 170a from the portable physical medium, and execute the program 170a. Further, the language identification program 170a may be stored in another computer, server apparatus or the like coupled to the computer 100 via a public line, the Internet, a LAN, a WAN, or the like, and the computer 100 may acquire the language identification program 170a from the other computer or the server apparatus, and execute the program 170a.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program for causing a computer to execute processing comprising:
converting a speech recognition result of speech recognition performed on an input voice for each of a plurality of languages into a phoneme string;
calculating a phoneme count for each of the plurality of languages from the corresponding one of the phoneme strings obtained by the conversion for the respective languages; and
identifying a type of language matched with the input voice based on the phoneme counts calculated for the respective languages.

2. The non-transitory computer-readable recording medium according to claim 1, wherein
the identifying includes identifying a language having the largest phoneme count among the plurality of languages as the language matched with the input voice.

3. The non-transitory computer-readable recording medium according to claim 1, wherein the processing further includes:
calculating a sentence likelihood for each of the plurality of languages based on a linguistic model from the speech recognition result of the speech recognition performed on the input voice for the respective languages, wherein
the identifying includes identifying the type of language matched with the input voice based on the phoneme counts calculated for the respective languages and the sentence likelihoods for the respective languages calculated based on the linguistic models.

4. The non-transitory computer-readable recording medium according to claim 3, wherein
the identifying includes extracting one or more languages in which the sentence likelihood based on the linguistic model is equal to or more than a predetermined threshold value from the plurality of languages, and identifying the language having the largest phoneme count among the extracted one or more languages as the language matched with the input voice.

5. The non-transitory computer-readable recording medium according to claim 3, wherein
the identifying includes identifying the language in which a score calculated from the phoneme count and the sentence likelihood based on the linguistic model is the highest as the language matched with the input voice.

6. A language identification method comprising:
converting, by a computer, a speech recognition result of speech recognition performed on an input voice for each of a plurality of languages into a phoneme string;
calculating a phoneme count for each of the plurality of languages from the corresponding one of the phoneme strings obtained by the conversion for the respective languages; and
identifying a type of language matched with the input voice based on the phoneme counts calculated for the respective languages.

7. The language identification method according to claim 6, wherein
the identifying includes identifying a language having the largest phoneme count among the plurality of languages as the language matched with the input voice.

8. The language identification method according to claim 6, further comprising:
calculating a sentence likelihood for each of the plurality of languages based on a linguistic model from the speech recognition result of the speech recognition performed on the input voice for the respective languages, wherein
the identifying includes identifying the type of language matched with the input voice based on the phoneme counts calculated for the respective languages and the sentence likelihoods for the respective languages calculated based on the linguistic models.

9. The language identification method according to claim 8, wherein
the identifying includes extracting one or more languages in which the sentence likelihood based on the linguistic model is equal to or more than a predetermined threshold value from the plurality of languages, and identifying the language having the largest phoneme count among the extracted one or more languages as the language matched with the input voice.

10. The language identification method according to claim 8, wherein
the identifying includes identifying the language in which a score calculated from the phoneme count and the sentence likelihood based on the linguistic model is the highest as the language matched with the input voice.

11. An information processing device, comprising:
a memory; and
a processor coupled to the memory and configured to:
convert a speech recognition result of speech recognition performed on an input voice for each of a plurality of languages into a phoneme string;
calculate a phoneme count for each of the plurality of languages from the corresponding one of the phoneme strings obtained by the conversion for the respective languages; and
identify a type of language matched with the input voice based on the phoneme counts calculated for the respective languages.

12. The information processing device according to claim 11, wherein the processor is configured to:
identify a language having the largest phoneme count among the plurality of languages as the language matched with the input voice.

13. The information processing device according to claim 11, wherein the processor is configured to:
calculate a sentence likelihood for each of the plurality of languages based on a linguistic model from the speech recognition result of the speech recognition performed on the input voice for the respective languages; and
identify the type of language matched with the input voice based on the phoneme counts calculated for the respective languages and the sentence likelihoods for the respective languages calculated based on the linguistic models.

14. The information processing device according to claim 13, wherein the processor is configured to:
extract one or more each languages in which the sentence likelihood based on the linguistic model is equal to or more than a predetermined threshold value from the plurality of languages; and
identify the language having the largest phoneme count among the extracted one or more languages as the language matched with the input voice.

15. The information processing device according to claim 13, wherein the processor is configured to:
identify the language in which a score calculated from the phoneme count and the sentence likelihood based on the linguistic model is the highest as the language matched with the input voice.
